(19) United States
(12) Patent Application Publication
(10) Pub. No.: US 2007/0281763 A1
(43) Pub. Date: Dec. 6, 2007

(54) Antenna for Radiocommunication Terminal

(76) Inventors: Gilles Durand, Eragny (FR); Lydie Robert, Antony (FR)

Correspondence Address: MORGAN LEWIS & BOCKIUS LLP, 1111 PENNSYLVANIA AVENUE NW, WASHINGTON, DC, 20004, US

(21) Appl. No.: 10/581,925

(22) PCT Filed: Dec. 9, 2004
(86) PCT No.: PCT/FR04/03177

§ 371 Date: Jun. 28, 2007

(30) Foreign Application Priority Data
Dec. 9, 2003 (FR) 0314379

(51) Int. Cl. H04M 1/00

(52) U.S. Cl. 455/575.7

(57) ABSTRACT

The invention relates to a radiocommunication terminal consisting of a housing comprising two shells, namely: a rear shell (20) and a front shell (30). The rear shell (20) covers an antenna space that is dedicated to a patch antenna (10) and a storage space that is dedicated to an energy-storing device (40), said antenna space being adjacent to the storage space. According to the invention, the terminal comprises a vacant space around the energy-storing device (40) between the printed circuit board (70) and the rear shell (20) and the space occupied by the antenna patch (10) extends over at least part of said vacant space.

The invention relates to an antenna for a radiocommunications terminal. One of the fields of application of the invention which is not exclusive, is that of mobile radiocommunications terminals operating in a radiocommunications system. The invention is notably applied, but not exclusively to a system or network according to the GSM850, GSM900, DCS, PCS and UMTS standards.

The antennas used in radiocommunications terminals are antennas which should transmit signals in the frequency bands as defined in the standards.

It is known how to use microstrips on a plane as an antenna for communications terminals, these antennas are also called patch antennas and are located inside the housing of the terminal. They mainly consist of a dielectric base at the surface of which is found the plane of the microstrips.

Different patch antennas of this type are known in the state of the art:

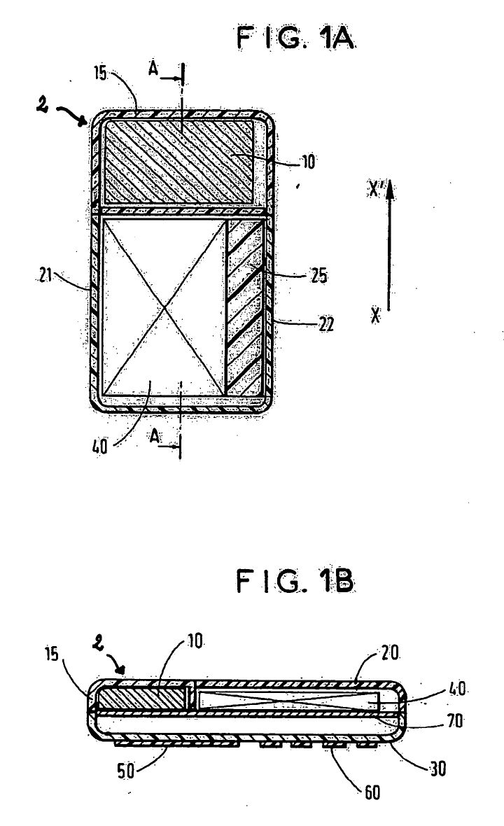

In a conventional known realization such as described in FIGS. 1A and 1B, the patch antenna 10 is completely integrated into the radiocommunications terminal.

The radiocommunications terminal comprises a housing 2 formed with:
two shells: a so-called rear shell 20 and a so-called front shell 30,
two side-walls parallel to the longitudinal axis of the terminal (parallel to the X-X′ axis) : a first wall 21 and a second wall 22, and with two walls perpendicular to the X-X′ axis, these walls delimiting the rear 20 and front 30 shells of the terminal.

The housing contains a printed circuit card 70 which extends on approximately the whole inner surface of the terminal and is, approximately located in the central portion of the terminal between the rear shell 20 and the front shell 30 of the housing of the terminal.

The space located between the printed circuit card 70 and the rear shell 20 is intended to receive the antenna 10 on the one hand, and an energy-storing device on the other hand. The space located between the printed circuit card 70 and the front shell 30 is intended to notably receive a display module, whereof only the screen 50 is illustrated, as well as an input module, notably comprising the keys of a keyboard 60.

The different components such as the antenna 10, the display screen 50 and the keyboard 60 are connected to the energy-storing device 40 via the printed circuit card 70.

The rear shell 20 of the housing is split into two: it comprises a hatch 15 covering the antenna 10 and another part covering the energy-storing device 40. As visible in FIGS. 1A and 1B, there are two contiguous compartments or spaces along the longitudinal axis of the housing, a first space dedicated to the energy-storing device 40 and a second space dedicated to the patch antenna 10.

The energy-storing device 40 has an overall size less than the rear shell 20 of the radiocommunications terminal, and a volume size less than the volume of the first space which is dedicated to it. This generates vacant space under the rear shell 20 of the terminal next to the energy-storing device 40.

In order to prevent the energy-storing device 40 from moving, the energy-storing device 40 for example rests against the first wall 21 of the rear shell 20 of the housing of the terminal and rests against a plastic part 25 occupying the vacant volume, this part 25 itself resting against the second wall 22 of the rear shell 20 of the housing of the terminal.

The hatch 15 enables the patch antenna 10 to be isolated from impacts and external dust.

As it may be seen in FIG. 1A, the antenna 10, located opposite the screen 50, for example occupies about the upper third of the terminal, along the longitudinal axis of the housing, and the two lower thirds of the terminal are thus occupied by the energy-storing device 40, located opposite the keyboard 60.

The dimension of this type of antenna is imposed by the reduced space left available by the arrangement of all the other components of the terminal. It is seen that the patch antenna 10 here has the shape of a rectangular parallelepiped practically occupying all the space which is dedicated to it. The dimensions of the plane in which the microstrips of the antenna 10 are located, are those of the hatched portion 10 of FIG. 1A.

The confinement of the antenna in a reduced space results in a transfer of electrical energy from the antenna into heat which propagates in the terminal and causes damages notably to the printed circuit card 70.

Further, because of the confinement of the antenna, its efficiency is reduced and it may be lowered below 40% and with a passband less than 6.5% in the GSM900 band.

Finally, the antennas in a near future should also cover different frequency bands, such as the frequency band GSM850 between 824 and 894 MHz for example.

Covering other power bands will require an increase in the size of the antennas relatively to their present size.

The object of the invention is to present a solution to these problems and to achieve a layout allowing the use of a less confined, more efficient antenna and which may cover i.a. an additional frequency band different from that covered with present antennas, and this without having to increase the dimensions of the housing.

For this purpose, the invention relates to a radiocommunications terminal such as defined in claim 1.

Other features and advantages of the invention will become apparent upon reading the following description of particular embodiments of the invention, given as an illustration and with no limitation, and of the drawings set forth below, wherein:

FIG. 1A already described, illustrates a schematic view of a radiocommunications terminal of the prior art, as seen from the back and without the rear shell.

FIG. 1B already described, illustrates a schematic view of the radiocommunications terminal as a longitudinal sectional view along the axis A-A of FIG. 1A with the rear shell.

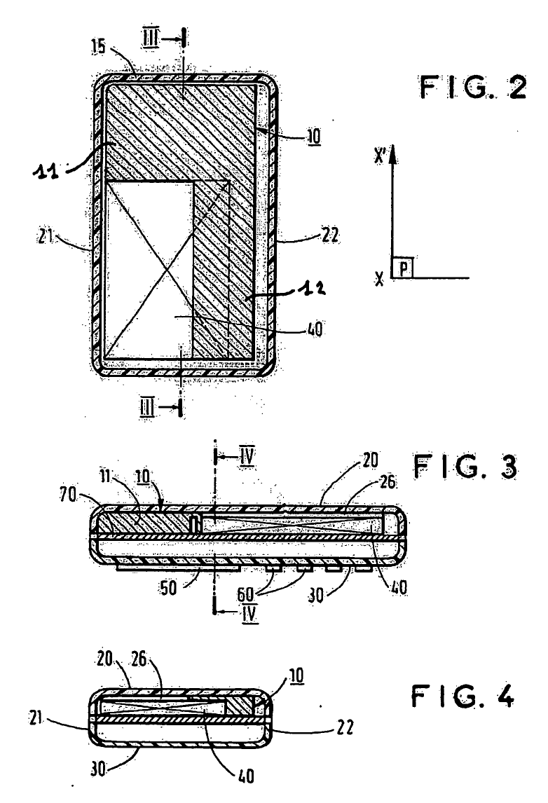

FIG. 2 illustrates a schematic view from the back of a radiocommunications terminal, without the rear shell, according to a first embodiment of the invention.

FIG. 3 illustrates a schematic view of the radiocommunications terminal according to the first embodiment of the invention as a longitudinal sectional view along the axis III-III of FIG. 2 passing through the central portion of the terminal.

FIG. 4 illustrates a schematic view of the radiocommunications terminal according to the first embodiment of the invention as a transverse sectional view along the axis IV-IV of FIG. 3.

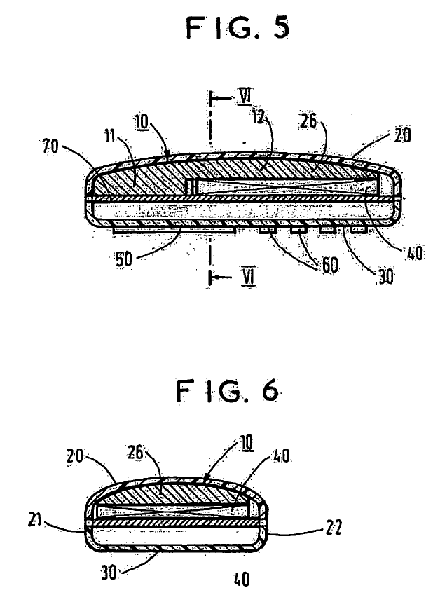

FIG. 5 illustrates a schematic view of a radiocommunications terminal according to a second embodiment as a longitudinal sectional view along an axis passing through the centre of the terminal.

FIG. 6 illustrates a schematic view of the radiocommunications terminal according to the second embodiment as a transverse sectional view along the axis VI-VI of FIG. 5.

In the following description, the invention is described in its application to radiocommunications terminals including all types of radio transceivers, such as for example a mobile telephone, a radio paging device or a personal digital assistant (PDA).

The radiocommunications terminal according to the invention may be of the GSM850, GSM900, DCS (Digital Communication System), UMTS (Universal Mobile Telecommunications System) type or even a telephone of the DECT (Digital European Cordless Telecommunications) type, this terminal may also further integrate GPS (Global Positioning System) or Wi-Fi (Wireless Fidelity) functions.

The housing of the terminal of FIG. 2 is formed with two sidewalls parallel to the axis of direction X-X′: a first wall 21 and a second wall 22, and with two walls perpendicular to the axis of direction X-X′ which delimit both front 30 and rear 20 shells of the terminal.

Under the rear shell 20, the antenna 10 is found and the energy-storing device 40, contiguous to the antenna 10.

The energy-storing device 40 has an upper surface extending in a plane P. This plane P is parallel to the plane defined by the inner surface of the rear shell 20 of the terminal.

The energy-storing device 40 supplies electrical energy to the components of the terminal, which require it for their operation. These components are i.a. the printed circuit 70, the antenna 10, the display screen 50 and the keyboard 60.

The energy-storing device 40 occupies a first space, or an accumulator space which is dedicated to it.

This accumulator space has an overall size less than the inner surface of the rear shell 20 of the housing and this generates vacant space around the energy-storing device 40.

In this embodiment, the vacant space consists of:
the space located under the antenna hatch 15 of FIG. 1A of the prior art, i.e., in the upper rear portion, for example the rear upper third of the terminal along the longitudinal axis of the housing, and
the space occupied by the plastic part 25 of FIG. 1A of the prior art, i.e., in the lower rear two thirds of the terminal between the energy-storing device 40 and the second wall 22 of the terminal.

In this embodiment, the energy-storing device 40 has a longitudinal dimension such that it mainly occupies the rear two thirds of the shell of the terminal.

As the present trend is to miniaturize components, it is very obvious that the energy-storing device 40 may be smaller and occupy less than the rear two thirds of the terminal; in that case, the vacant space would be larger.

According to the invention, the vacant space will be used at least in part, for increasing the space dedicated to the patch antenna 10.

Thus, as shown in FIG. 2 and FIG. 3, the antenna 10 which occupies the second space defined earlier as being contiguous to the accumulator space along the longitudinal axis of the housing, will also extend parallel to the plane P in order to occupy part of the vacant space around the energy-storing device.

The antenna space 10 is defined by the vacant space defined above and by at least a portion of the space 26 located above the plane P between the energy-storing device 40 and the rear shell 20 of the terminal.

In the first embodiment, as visible in FIG. 2, the antenna 10 has an inverted-L shape with a base 11 and a stem 12.

The antenna 10 occupies with its portion forming a base 11, the upper third portion of the rear shell of the terminal and with its portion forming a stem 12, for example the lower two thirds of the rear shell of the terminal between the energy-storing device 40 and the second wall 22. Further the portion forming a stem 12 advantageously provides the function for maintaining the energy-storing device in the location and in the place of the part 25 used in the prior art (seen FIG. 1A).

The microstrips of the patch antenna are made on the plane P between the energy-storing device 40 and the rear shell 20 of the terminal.

The global volume of the antenna 10 is therefore larger than that of the prior art.

This allows the efficiency of the antenna to be increased to 50-60% in the GSM900 mode (required frequency band from 880 to 960 MHz according to the standard). This also allows a frequency band to be obtained which is closer to that required by the GSM standard, i.e., a bandwidth of the order of 7% (for 8.7% required according to the standard) versus 6.5% in the prior art.

With a larger antenna volume 10, it is easier to produce an antenna having different resonance frequencies, for example, when it is desired to integrate GPS or WiFi functions (with resonant frequencies of 1.5 GHz and 2.5 GHz respectively) into a GSM900 or DCS or UMTS type terminal.

It is also possible to further increase the global volume of the antenna 10 by covering with some antenna volume, all the vacant space around the accumulator, and notably also the space 26 located above the plane P between the energy-storing device 40 and the rear shell 20 of the terminal as illustrated in FIG. 5.

The antenna volume between the energy-storing device 40 and the rear shell 20 of the housing of the terminal may further be larger for a terminal, for which the rear shell 20 of the housing is slightly convex, as shown in FIG. 5 and in FIG. 6.

To do this, the microstrips of the patch antenna 10 are made on a surface having a profile which is complementary to the inner surface of the rear shell, as illustrated in FIGS. 5 and 6.

Further, the projection of the antenna of the printed circuit 70, i.e., the portion of the antenna 10, directly connected on the printed circuit 70, is larger than for the antennas of the prior art, notably for the terminal described in FIGS. 2, 3 and 5.

Indeed, this projection is increased by the surface 25 covered in the prior art with the plastic part with which the accumulator may be held in the terminals in FIG. 1B.

This provides further increase in the efficiency of the antenna.

It is thereby possible to increase the global volume of the antenna 10 by occupying all the space left vacant next to the energy-storing device 40 and between the energy-storing device 40 and the rear shell 20 of the housing of the terminal.

The antenna 10 will be all the more extensive since the energy-storing device 40 will have a more reduced surface and thickness, which is the present trend.

1. A radiocommunications terminal comprising.
a housing formed with a rear shell and a front shell, the housing containing:
a printed circuit card extending parallel to the rear shell and to the front shell;
an energy-storing device placed in a first dedicated space located between the rear shell sand the printed circuit card, having an upper surface extending in a plane parallel to the rear shell;
a patch antenna placed in a second space also located between the rear shell and the printed circuit card, said second space being contiguous to the first space, said patch antenna being connected to the energy-storing device via the printed circuit card, wherein the terminal includes a vacant space around the energy-storing device between the printed circuit card and the rear shell and in that said second space occupied by said patch antenna extends over at least part of this vacant space.

2. The radiocommunications terminal according to claim 1, wherein said second space occupied by said patch antenna extends over all the vacant space.

3. The radiocommunications terminal according to claim 1, wherein the patch antenna includes microstrips made in a plane extending between the upper surface of the energy-storing device and the rear shell.

4. The radiocommunications terminal according to claim 3, wherein the patch antenna includes microstrips made in a plane with substantially the same surface as the rear shell of the housing.
